(19) United States
(12) Patent Application Publication
(10) Pub. No.: US 2016/0212191 A1
(43) Pub. Date: Jul. 21, 2016

(54) METHOD OF ACQUISITION OF A CODING/DECODING MODULE IN A TELECOMMUNICATIONS NETWORK

(71) Applicant: ORANGE, Paris (FR)

(72) Inventors: Bruno Chatras, Paris (FR); Sebastien Cubaud, Rennes (FR)

(21) Appl. No.: 14/899,111

(22) PCT Filed: Jun. 19, 2014
(86) PCT No.: PCT/FR2014/051525

§ 371 Date: Dec. 16, 2015

(30) Foreign Application Priority Data
Jun. 21, 2013 (FR) 1355943

(51) Int. Cl. H04L 29/06

(52) U.S. Cl. CPC H04L 65/607; H04L 65/1069

(57) ABSTRACT

Method of acquisition in a communication network, of at least one coding/decoding module, for encoding/decoding at least one data stream relating to a session between a first and a second entity, an application dialogue being associated with said session, said method being implemented by the first entity and comprising the following steps:
opening of said application dialogue associated with said session;
reception from said second entity of a proposed list of coding/decoding modules for said session;
selection from the received list of coding/decoding modules of at least one coding/decoding module to be acquired;
acquisition of said at least one module from a supplier entity, the application dialogue being kept open;
encoding/decoding of said at least one data stream relating to said session by means of said at least one module acquired.

The invention lies in the field of data transport during a communication session, and relates more particularly to a method of acquisition of a coding/decoding module for encoding/decoding one or more data streams associated with a session between two entities.

It is known to use a coding/decoding module, also called a codec, for the encoding and/or decoding of a data stream. Such a module makes it possible to compress and decompress the data of the stream exchanged between two entities. It thus meets various needs, both in terms of quality of retrieval of the transported data and in terms of limitation of the network resources used during data transport. These modules find their applications in numerous fields such as telephony, live content broadcasting, videoconferencing, etc. There exists moreover a large number of coding/decoding modules, each having their own specific features.

A coding/decoding module is used when two entities of a communication network exchange data streams, especially when the streams exchanged are of video, voice, high-definition image type, etc. However, this exchange is possible only when each of the two entities has one and the same coding/decoding module. The two entities, before being able to exchange a data stream, generally agree on the coding/decoding module which will be used for their exchanges during a coding/decoding module negotiation step.

The proliferation in the number of existing coding/decoding modules considerably increases the probability of two user entities being in a configuration where they do not have a common coding/decoding module for their subsequent exchanges. Likewise, a communication guaranteeing certain quality of service criteria or else being limited by constraints of the network may require the use of a particular coding/decoding module during the transport of the data streams associated with this communication. The communication meeting these criteria and/or constraints may not be established in the absence of the coding/decoding module requested.

To avoid these failure situations, the commonest solution in present-day networks consists in inserting between the two entities, an intermediary entity which has the coding/decoding modules used by each of the other two entities, so as to transcode the data streams associated with the communication. This solution nonetheless comprises drawbacks intrinsically related to the very introduction of intermediary entities between the user entities, especially a further complicating of the procedures for establishing sessions, a degrading of the quality of experience, decreased network performance, etc.

A need exists for a solution that is less complicated for a telecommunications operator to implement.

A technical document, dated Mar. 25, 2011, from the telecommunications standardization Department of the International Telecommunications Union, entitled “HSTP-AMSR, AMS Requirements”, describes the requirements relating to an advanced multimedia architecture, the AMS (Advanced Multimedia System). This document mentions the possibility, in such an architecture, of a user entity downloading coding/decoding modules made available by entities of the network or other user entities, when this user entity does not have the module requested.

The technical modalities for implementing this downloading are not described, in particular the criteria for triggering downloading and the way in which an entity can determine which modules are to be downloaded and on which server(s).

One of the aims of the invention is to remedy inadequacies/drawbacks of the prior art and/or to afford improvements thereto.

According to a first aspect the invention relates to a method of acquisition in a communication network, of at least one coding/decoding module, for encoding/decoding at least one data stream relating to a session between a first and a second entity, said method being implemented by the first entity and comprising the following steps:

a/reception of an application message originating from the second entity comprising a list of at least one proposed coding/decoding module for the session;
b/selection on the basis of the list received of at least one coding/decoding module to be acquired;
c/acquisition of said at least one module from a provider entity, an application dialog associated with the session remaining established between the two entities during the acquisition;
d/encoding/decoding of said at least one data stream relating to the session by means of said at least one module acquired.

The method of acquisition allows two entities to exchange data streams, with the aid of a coding/decoding module which was not available initially at one of the entities. It thus makes possible a communication which was not possible between two entities other than by way of intermediary transcoding entities within the network. By lifting this constraint, the method makes it possible in particular to avoid the use of intermediary entities during an exchange of data streams between two entities which do not have compatible coding/decoding modules. The procedure for establishing sessions is simplified and the quality of experience enhanced. The use of the network resources is also improved.

The method furthermore allows data transport relating to a session between two entities independently of the coding/decoding modules that these entities have at their disposal. The acquisition of a coding/decoding module also allows an entity to import software functionalities for coding/decoding that it does not possess in terms of hardware. It is therefore not necessary for an entity to have native hardware functionalities for coding/decoding. The hardware design of an entity implementing the method is in fact simplified thereby. It should be noted that the latter point renders the entity compliant with requirement MED-101, relating to the terminals in an AMS architecture, of the above-cited document “HSTP-AMSR, AMS Requirements”.

The acquisition of a coding/decoding module moreover offers a means of preventing the obsolescence of the entity implementing the method, by rendering it compatible with entities having the most recent coding/decoding modules.

It should be noted that the entity implementing the method is not restricted to a user entity (mobile terminal, multimedia reader, SIP telephone, etc.). It may also be for example a network entity implementing a transcoding (VoIP gateway, Session Border Controller, etc.).

According to a particular characteristic, the method of acquisition proposes the acquisition of at least one coding/decoding module for the encoding/decoding of at least one data stream relating to a session in the course of establishment, the list of coding/decoding modules which is proposed by the second entity not comprising any coding/decoding module common to the two entities, the method furthermore comprising the following steps:
dispatching of a placement-on-hold message destined for the second entity, making it possible to maintain the application dialog associated with the session;
establishment of the session, once said at least one coding/decoding module is available for use.

The acquisition of a module in the course of establishment of a session between two entities, and the maintaining of an open application dialog associated with the session, allow an entity to respond positively to the request of another entity for establishment of a session comprising an exchange of data. It is thus possible to increase the number of successful calls between two entities, a successful call being defined as a session establishment request for which it has actually been possible to establish a session. The dispatching of a placement-on-hold message destined for the entity on the initiative of the application dialog associated with the session makes it possible in particular to make the latter entity wait for the time of the acquisition of the module requested for the exchange of data between the entities. An abrupt interruption of the communication between the two entities can thus be avoided, and the quality of the user experience be improved.

According to a particular characteristic the method of acquisition furthermore comprises the emission of a hold message destined for the user of the first entity before establishment of the session, this emission being conditioned by a use of the first entity.

The quality of experience can also be improved by the emission of a hold message destined for the user of the entity invited to establish a session. This emission is advantageously triggered by a use of the invited entity. It entails for example a so-called recorded delay audio announcement broadcast when the invited user answers his telephone. When the method is implemented by an entity of XMPP (eXtensible Messaging and Presence Protocol) client type or a browser, this hold message is for example a text displayed on the screen upon a user action (e.g. a click on a button in a graphical interface).

According to another particular characteristic the application dialog associated with the session between two entities during the acquisition is opened in association with an established session, the first and second entities having negotiated a use of a common coding/decoding module for the encoding/decoding of at least one data stream associated with the session, furthermore comprising a step of modifying the session so as to encode/decode said at least one data stream by means of the coding/decoding module acquired.

The method of acquisition allows two entities that have established a session with a coding/decoding module that they have in common, to modify the coding/decoding module used during the transport of data in the course of a session. A communication with a higher level of quality can in particular be proposed in the course of an already established session. The comfort, for example of listening or of viewing, of the users can thus be improved. The method makes it possible furthermore not to constrain the establishment of a communication between two entities by the coding/decoding module acquisition lag. Moreover, acquisition of the module in the course of a session does not require that the session be interrupted. The method makes it possible to prevent user dissatisfaction resulting from such interruptions.

According to another particular characteristic, during step a/of the method of acquisition, the list received comprises at least one item of information relating to at least one entity able to provide a coding/decoding module.

The association of at least one item of information relating to at least one provider entity with a coding/decoding module allows fast and easy identification of provider entities capable of delivering the coding/decoding module. In the case where several entities are able to provide one and the same coding/decoding module, this information also makes it possible to define a provider entity selection policy.

According to another particular characteristic said at least one item of information relating to at least one entity able to provide a coding/decoding module is inserted into the list by an intermediary network entity.

The information relating to at least one entity able to provide a coding/decoding module can advantageously be obtained from an intermediary network entity. It is thus possible for a first entity proposing to a second entity the use of a particular coding/decoding module, to obtain this information from an SIP (Session Initiation Protocol) proxy belonging either to the network of the first entity, of the second entity, or of a transit network.

According to another particular characteristic, said at least one coding/decoding module to be acquired is selected as a function of at least one property of the module and of at least one constraint associated with the session.

A selection as a function of properties of a module exhibits the advantage of being able to choose a module adapted to particular constraints associated with the session. These may be for example properties relating to the quality of service requested, to the network resources necessary for the data transport associated with the session, or else of sensitivity to packet loss.

According to another particular characteristic, the method of acquisition furthermore comprises a determination of the provider entity as a function of at least one item of information associated with at least one of the first and second entities.

The entity is thus autonomous in respect of determining the provider entity.

According to another particular characteristic, the item of information relating to the provider entity is obtained by way of a dynamic configuration protocol.

The obtaining of an item of information relating to a provider entity by way of a configuration protocol allows further flexibility in the configuration of the entity needing to acquire a coding/decoding module. In particular a parametrization prior to the acquisition of the module by the user of the entity, or by its manufacturer, is avoided. Furthermore, it is not necessary to issue strong assumptions about the structure of the identities and/or IP addresses in order to be able to deduce therefrom the address of a provider entity. This makes it possible for example to circumvent a universal convention for the construction on the basis of a domain name of a Web address relating to a provider entity, or the interrogation of a provider entities name server.

According to a second aspect the invention relates to an entity designed to acquire in a communication network at least one coding/decoding module, this module being used by the entity to encode/decode at least one data stream relating to a session between the entity and a second entity, comprising:
a management module, designed to manage an application dialog associated with the session;
a first dispatch/reception module, designed to receive from the second entity a proposed list of coding/decoding modules for the session;
a selection module, designed to select on the basis of the received list of coding/decoding modules, at least one coding/decoding module to be acquired;
a second dispatch/reception module, designed to dispatch a request for a coding/decoding module from a provider entity, and to receive the module in response to this request;
storage means, designed to store at least one coding/decoding module.

The advantages stated in respect of the method of acquisition according to any one of the characteristics of the first aspect are directly transposable to the entity according to the second aspect.

The processing module makes it possible for example to compile if necessary the coding/decoding module before its dispatch, in a language comprehensible by the entity which requests the acquisition thereof. The time necessary for the preparation by the first entity of the coding/decoding module for use can thus be reduced.

According to a third aspect the invention relates to a system in a communication network, this system comprising:
at least one entity according to the second aspect;
a provider entity, in a communication network, designed to provide at least one coding/decoding module to said at least one entity according to the second aspect for encoding/decoding at least one data stream relating to a session between the first entity and a second entity, comprising:
   storage means, designed to store at least one coding/decoding module;
   a dispatch/reception module, designed to receive a request for acquisition of a coding/decoding module from said at least one entity according to the second aspect, and to dispatch the module to it in response to this request.

According to another particular characteristic, the provider entity of the system according to the third aspect furthermore comprises a processing module, designed to render the encoding/decoding module, usable by said at least one entity according to the second aspect as soon as it is acquired.

According to another particular characteristic, the provider entity of the system according to the third aspect furthermore comprises a calculation module, designed to calculate a time of making available of the coding/decoding module at said at least one entity according to the second aspect.

According to a fourth aspect, the invention also relates to a program for an entity, comprising program code instructions intended to control the execution of the steps of the above-described method of acquisition, when said program is executed by said entity and a recording medium readable by an entity and on which a program for an entity is recorded.

According to a fifth aspect, the invention also relates to a program for a provider entity, comprising program code instructions intended to control the execution of the steps of the above-described method of acquisition, when said program is executed by said provider entity and a recording medium readable by a provider entity and on which a program for a provider entity is recorded.

The invention will be better understood with the aid of the following description of particular embodiments, with reference to the appended drawings in which:

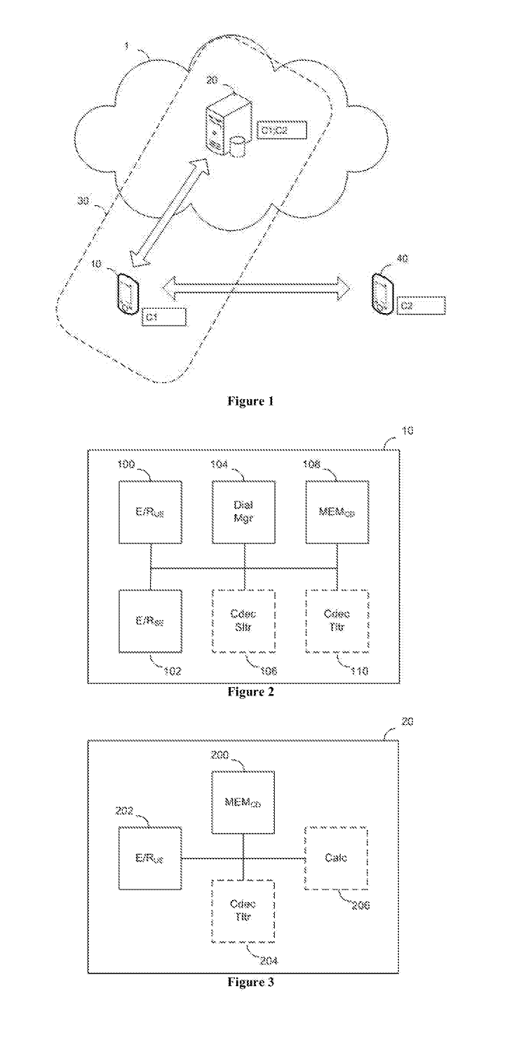

FIG. 1 represents a system for acquiring a coding/decoding module;

FIG. 2 represents an entity implementing a coding/decoding module acquisition method according to a particular embodiment;

FIG. 3 represents a provider entity according to a particular embodiment;

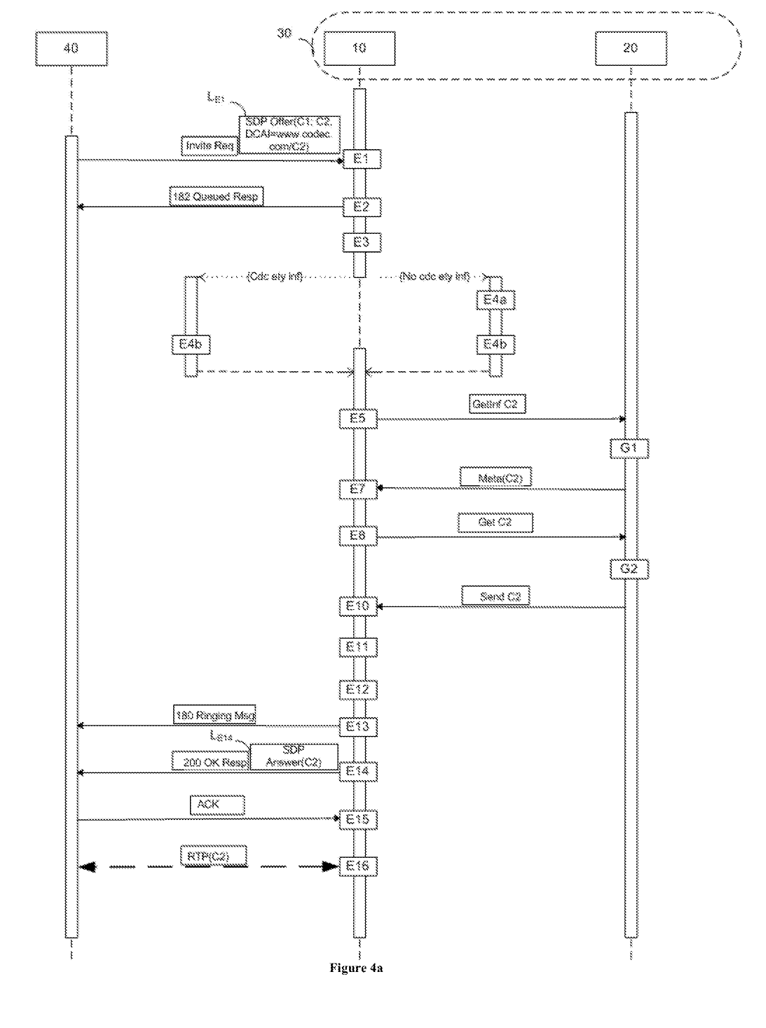

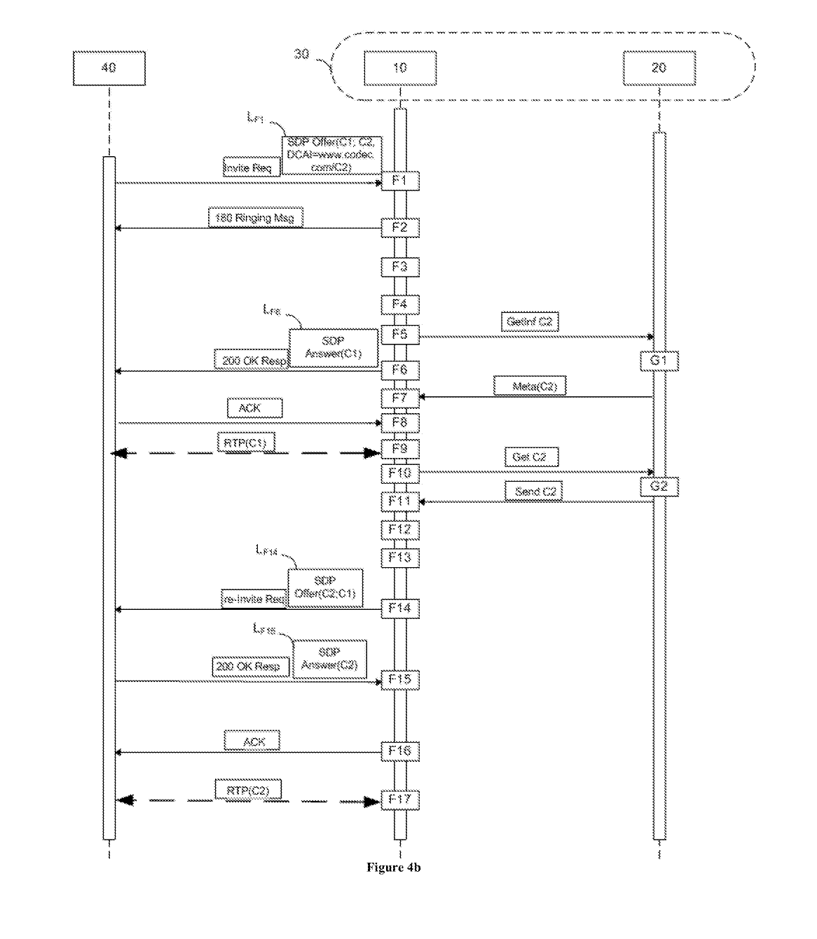

FIGS. 4a and 4b represent steps of a method of acquisition of a coding/decoding module in a particular embodiment.

FIG. 1 represents a system for acquiring a coding/decoding module in a communication network 1. The network 1 is for example a telecommunications operator network. It comprises a provider entity 20, one of whose functions is to store coding/decoding modules so as to offer them by downloading to entities requesting such a module. A coding/decoding module acquisition system 30 consists of an entity 10 acquiring this module and of this module's provider entity 20.

In the embodiment described, a second entity 40 establishes a communication with the first entity 10. The entities 10, 40 are for example a personal computer, a telephone, a mobile terminal or else a tablet.

FIGS. 4a and 4b describe the steps of the method of acquisition of a coding/decoding module according to two particular embodiments.

FIG. 4a presents an acquisition carried out in the course of the establishment of a multimedia session between the first and second entities 10, 40. The multimedia session corresponds for example to the audio stream exchanged during a telephone conversation, to the streams associated with a videoconference session, or to any other exchange requiring the transport of a multimedia stream between the first 10 and second 40 entities.

The second entity 40 has the coding/decoding modules C1 and C2. The first entity 10 does not have either of these two modules. These entities implement for example the SIP application protocol.

In a step E1, the first entity 10 receives an SIP INVITE message originating from the second entity 40. An application dialog then starts between the two entities. This application dialog consists, in the present embodiment, of the SIP exchanges between the two entities.

The SIP INVITE message received in step El furthermore includes an SDP (Session Description Protocol) offer such as described by the IETF (Internet Engineering Task Force) in RFC (Request for Comments) 3264. This SDP offer comprises a list L_{E1} of coding/decoding modules. The list L_{E1} consists of two identifiers of the coding/decoding modules C1 and C2 proposed by the second entity 40 for the establishment of the multimedia session. The address of a provider entity 20 is also associated with the identifier C2 in the SDP offer. This address identifies a provider entity from which the coding/decoding module C2 can be obtained, for example “www.codec.com/C2”. By way of illustrative example the coding/decoding modules proposed by the second entity 40 are a G.711 coding/decoding module C1 and an AMR-WB (Adaptive Multi-Rate Wideband) coding/decoding module C2.

During a step E2, the first entity 10 checks the list L_{E1} and determines that it does not have any coding/decoding module in common with the second entity 40. The first entity 10 then dispatches a message “182 Queued” to indicate that it is temporarily unavailable and to place the second entity 40 on hold. This is manifested for example by the emission of a particular tone or of a voice announcement intended to make the requester wait. Moreover the first entity does not alert the requested party of the arrival of a call (i.e. the telephone does not ring, no message is displayed on the screen). This makes it possible not to degrade the quality of experience perceived by the requested party. In another embodiment, the requested party is normally informed of the arrival of a call (e.g. the telephone rings), and an announcement inviting him to wait is broadcast when he answers the call.

The first entity 10 thereafter selects, in a step E3, a coding module to be acquired from among the offer of modules L_{E1} which was received previously from the second entity 40. In the present embodiment, the first entity 10 chooses to acquire the coding/decoding module with identifier C2. This selection is carried out as a function of the properties of the coding/decoding module and of its appropriateness to the type of multimedia session requested. It may in particular entail properties of the coding/decoding module which relate to the desired quality of service in respect of the session to be established: for example, sound of ordinary quality, or high-definition sound. It may also entail properties related to the network resources consumed, for example the bandwidth requested by a coding/decoding module. In the case of a network where packet losses are frequent, the sensitivity of a coding/decoding module to packet loss can also advantageously be taken into account in the choice of the module. The information relating to the properties of the coding/decoding modules is associated with the list of modules of the SDP offer L_{E1} received by the first entity 10 in step E1. However, no limiting character exists in regard to the way in which this information is obtained. In another embodiment, this information is for example obtained by interrogation of a reference base of the coding/decoding modules. This base is for example stored locally by the first entity 10, or on a remote server within the network.

In a step E4b, the first entity 10 selects a provider entity. In the embodiment described, this is the provider entity with address www.codec.com.

In the case where it has not been possible to determine any provider entity on the basis of the information contained in the SDP offer L_{E1}, in a step E4a which precedes step E4b, the first entity 10 obtains addresses of provider entities by virtue of a provider entities discovery mechanism. The address of a provider entity is for example obtained on the basis of an identifier such as the IP address of the second entity 40 in the network, and of an inverse DNS (for Domain Name Server) interrogation on the basis of this address. In another embodiment, the provider entity can also be determined on the basis of information obtained by way of a dynamic configuration protocol (DHCP, BBF TR-69, OMA DM, etc.). This information is for example obtained during the acquisition of an IP (Internet Protocol) address by the first entity 10.

In a step E5, the first entity 10 dispatches a request destined for the provider entity previously selected in step E4b so as to acquire the coding/decoding module of identifier C2. This request is accompanied by parameters specifying to the provider entity 20 that the coding/decoding module must be provided compiled so as to be executable by its operating system. The various options specifying the processings requested by the provider entity on the coding/decoding module before dispatch are dispatched with the request for acquisition of the module. These entail for example parameters in a URL (Uniform Resource Locator) link. It should be noted that depending on the number of coding/decoding modules to be acquired by the first entity 10, several acquisition requests may be dispatched in parallel destined for one or more provider entities.

In a step G1, the provider entity 20 receives the coding/decoding module acquisition request transmitted by the first entity 10, and estimates a time of making available of the compiled module. In one embodiment where the compilation of the module is not requested, not necessary, or else not proposed by the provider entity 20, this step is optional.

During a step E7, the first entity 10 receives the estimated time of making available of the compiled coding/decoding module with the information relating to the various versions of the coding/decoding module at the disposal of the provider entity 20. This information lists in particular the set of formats (e.g., interpretable script files, compiled files) in which the coding/decoding module C2 is available. Said information is for example dispatched to the first entity 10 in the form of an XML metadata file. When no format meets the criteria formulated by the first entity 10 during step E5, the provider entity 20 redirects the acquisition request to another provider entity. If the provider entity does not know any another provider entity, it rejects the request for acquisition of the first entity 10 (not represented in FIG. 4a). It should be noted that the estimated time of making available of the compiled coding/decoding module may advantageously be used by the first entity 10 to calculate and inform the user of an estimated time remaining before establishment of the communication. User experience is thus improved.

In a step E8, the first entity 10 confirms its request for acquisition of the coding/decoding module of identifier C2 by choosing one or more formats proposed by the provider entity 20 which meet its needs or constraints of use of the module.

The provider entity 20 compiles the requested coding/decoding module, and then applies a compression algorithm to it in a step G2. In another embodiment, this step is either carried out partially, or optional. This is especially the case when the coding/decoding module need not be compiled in order to be used by the first entity 10, or when the quantity of data to be dispatched is small and consequently need not be compressed before dispatch.

In a step E10, the provider entity 20 dispatches the coding/decoding module C2 in the format or formats requested by the first entity 10.

The coding/decoding module C2 is thereafter prepared by the first entity 10 so as to be rendered ready for use in a step E11. This preparation consists for example in storing the module locally so as to render it accessible to the applications or primitives of the operating system of the first entity 10 charged with the encoding and the decoding.

Once the coding/decoding module has been acquired and is ready to be used, the user of the first entity 10 is informed thereof during a step E12. This item of information is for example communicated to the user of the first entity 10 by the display of a message on the screen, or the emission of a ring tone.

Next, in a step E13, the first entity 10 also informs the second entity 40 by the dispatching of a message “180 Ringing” that it is ready to establish the data stream transport. It should be noted that this message is dispatched only once the coding/decoding module C2 has been acquired. The perceived user experience is consequently not degraded.

When the user of the first entity 10 answers the call, the first entity 10 dispatches (step E14) a response 200 OK including an SDP response L_{E14} indicating to the second entity 40 that the coding/decoding module C2 has been chosen.

The first entity 10 receives a message of acknowledgment of the second entity 40 (step E15), and the multimedia session using the coding/decoding module C2 is established (step E16).

The embodiment described comprises a step E4a of discovering provider entities, and E4b of selecting a provider entity. In another embodiment steps E4a and E4b are optional. In this case the association between a coding/decoding module and a provider entity able to provide it is defined by static configuration of the first entity 10.

FIG. 4b presents an acquisition carried out during a multimedia session already established between the two entities 10, 40. In this embodiment, the first entity 10 has the coding/decoding module of identifier C1, and the second entity 40 the coding/decoding modules C1 and C2. In a step F1, the first entity 10 receives an SIP INVITE message originating from the second entity 40. An application dialog then starts between the two entities. This application dialog consists, in the present embodiment, of the SIP exchanges between the two entities.

The SIP INVITE message received in step F1 furthermore includes an SDP offer. This SDP offer comprises a list L_{F1} of coding/decoding modules. The list L_{F1} consists of two identifiers of coding/decoding modules C1 and C2 proposed by the second entity 40 for the establishment of the multimedia session. The address of a provider entity is also associated with the identifier C2 in the SDP offer. This address indicates a provider entity from which the coding/decoding module identified by C2 can be obtained, for example “www.codec.com/C2”.

During a step F2, the first entity 10 indicates to the second entity 40 that the user is notified of the incoming session by the dispatching of a message “180 Ringing”. For example, a ring tone emitted by the first entity 10 informs the user thereof.

The first entity 10 thereafter selects, in a step F3, a first coding module C1 common to the two entities and a second coding module C2 to be acquired from among the offer of modules L_{F1} which was received previously from the second entity 40. This selection of the coding/decoding module of identifier C2 to be acquired is carried out in a manner similar to step E3 described in conjunction with the first embodiment. The first coding module C1 is available to establish the multimedia session.

In a step F4, the first entity 10 selects a provider entity. In the embodiment described this is the provider entity with address www.codec.com. This step F4 is similar to step E4b described in conjunction with the first embodiment.

In the case where it has not been possible to determine any provider entity on the basis of the information contained in the SDP offer L_{F1}, the first entity 10 obtains provider entities by virtue of a provider entities discovery mechanism not represented in FIG. 4b, as described previously in conjunction with the first embodiment.

In a step F5, the first entity 10 dispatches a request for acquisition of the coding/decoding module of identifier C2 destined for the previously chosen provider entity. This request is accompanied by parameters specifying to the provider entity 20 that the coding/decoding module must be provided compiled so as to be executable by its operating system. This step F5 is similar to step E5 described previously in conjunction with the first embodiment.

In a step G1, the provider entity 20 receives the request for acquisition of the coding/decoding module, and estimates a time of making available of the compiled module. In one embodiment where the compilation of the module is not requested, not necessary, or else not proposed by the provider entity, this step is optional.

The first entity 10 thereafter dispatches (step F6) a response “200 OK” including an SDP response L_{F6} indicating to the second entity 40 that the coding/decoding module of identifier C1 has been chosen for the establishment of the multimedia session.

During a step F7, the first entity 10 receives the estimated time of making available of the compiled coding/decoding module with the information relating to the various versions of the coding/decoding module at the disposal of the provider entity 20. This information lists in particular the set of formats (e.g., interpretable script files, compiled files) in which the coding/decoding module is available. Said information is for example dispatched to the first entity 10 in the form of an XML metadata file. When no format meets the criteria formulated by the first entity 10 during step F5, the provider entity 20 redirects the acquisition request to another provider entity. If the provider entity does not know any other provider entity, it rejects the request for acquisition of the first entity 10 (not represented in FIG. 4b).

The first entity 10 receives a message of acknowledgment of the second entity 40 (step F8) in response to the message “200 OK”. A first multimedia session using the coding/decoding module of identifier C1 is then established (step F9). The first and second entities 10, 40 thus do not have to wait until the end of the acquisition of the coding/decoding module C2 to exchange multimedia streams, these latter being encoded in a first phase with the aid of the coding/decoding module of identifier C1.

In a step F10, the first entity 10 confirms its request for acquisition of the coding/decoding module of identifier C2 by choosing one or more formats proposed by the provider entity 20 which meet its needs or constraints of use of the module.

The provider entity 20 compiles the requested coding/decoding module, and then applies a compression algorithm to it in a step G2. In another embodiment, this step is either carried out partially, or optional. This is especially the case when the coding/decoding module need not be compiled in order to be used by the first entity 10, or when the quantity of data to be dispatched is small and consequently need not be compressed before dispatch.

In a step F11, the first entity 10 receives from the provider entity 20 the coding/decoding module in the requested format or formats.

The coding/decoding module C2 is thereafter prepared by the first entity 10 so as to be rendered ready for use in a step F12. This preparation consists for example in storing the module locally so as to render it accessible to the applications or primitives of the operating system of the first entity 10 charged with the encoding and the decoding.

Once the coding/decoding module of identifier C2 has been acquired and is ready to be used, the user of the first entity 10 is informed thereof during a step F13. This item of information is for example communicated to the user of the first entity 10 by the display of a message on the screen.

Next in a step F14, the first entity 10 requests to modify the multimedia session by the dispatching of a message “re-INVITE” including an SDP offer L_{F14} with the identifier C2 of the module acquired, alone or in first position. This makes it possible to notify the second entity 40 that the coding/decoding module of identifier C2 is now available for the encoding and/or decoding of the multimedia streams.

The first entity 10 receives a message “200 OK” during a step F15, indicating to it that the second entity 40 has accepted the modification request.

The first entity 10 acknowledges by a message ACK the reception of the response message “200 OK” (step F16), and the multimedia session continues by using the coding/decoding module C2 (step F17).

In this second embodiment, steps F2 to F12 of the method of acquisition have been described sequentially; however the exchanges between the first entity 10 and the second entity 40 on the one hand, and between the first entity 10 and the provider entity 20 on the other hand are independent. Hence step F4 can be carried out in parallel with step F3, likewise steps F2, F6, F8 and F9 considered successively can also be carried out in parallel with steps F3, F5, F7, F10, F11, F12 and F13 considered successively.

In another embodiment, step F4 is optional. In this case, the association between a coding/decoding module and a provider entity able to provide it is defined by static configuration of the first entity 10.

In the embodiments described steps E3 and F3 are also optional. A coding/decoding modules acquisition policy consisting for the first entity 10 in systematically acquiring any module that it is invited to use and which is not at its disposal may for example be defined.

It should be noted that in another embodiment the address of the provider entity obtained during steps E1 and F1 is not necessarily unique. Several provider entities may indeed be able to provide one and the same coding/decoding module. In another embodiment, other information relating to the provider entities is advantageously provided in the form of parameters in the SDP offer L_{E1}. This information relates for example to the delivery modalities as well as to the processings performed on a coding/decoding module before dispatch by a provider entity. Still in another embodiment numerous selection policies are possible as regards the selection of the provider entity. It is for example possible to choose a provider entity as a function of its capabilities for forwarding a module, of its capability to translate a coding/decoding module into a machine language comprehensible to the module's recipient entity, of its location within the network, etc.

Moreover no limiting character exists in regard to the types of data transported and to the types of coding/decoding module used during this transport between the entities 10 and 40. The transported data stream can also be a video stream, a combination of audio and video streams, or more generally of any type of multimedia stream. The system makes it possible in particular to acquire any type of coding/decoding module.

In a particular embodiment, the second entity 40 can itself be provider entity. In this case, no intermediary exists between the first and second entities 10 and 40 for the acquisition of the coding/decoding module.

In another embodiment, the method of acquisition of a coding/decoding module is implemented by intermediary entities of the network, such as transcoding entities, these latter having for example a role of transcoder between two user terminals. They make it possible for example to transcode a stream encoded with a coding/decoding module M1 into a stream encoded with a coding/decoding module M2.

In another embodiment, the information relating to a provider entity and to a coding/decoding module is inserted by an intermediary network entity into the list of modules of coding/decoding which is proposed for the session between the first and the second entity. This intermediary network entity is for example an SiP proxy which relays the SIP messages between the two entities.

The embodiments have been described with an implementation based on the SIP protocol. However, no limiting character exists in regard to the exchange technologies used. The invention can in particular be adapted to be implemented above the HTTP (Hypertext Transfer Protocol) protocols or any other suite of protocols integrating a coding/decoding module negotiation procedure.

The embodiments may also be adapted for an entity of STN-Web client type. The information included in an SDP offer is then transmitted by way of a script of an STN-Web server in the form of an SDP offer as in the case of the SIP protocol or of an equivalent using another syntax (XML, JSON, etc.).

The protocols used for the application dialog between the two entities 10, 40 are furthermore not necessarily identical. The method of acquisition is in this case adapted so as to involve intermediary entities whose role is to translate the exchanges between the two entities 10, 40.

FIG. 2 represents a first entity 10 adapted for acquiring a coding/decoding module according to a particular embodiment. It comprises in particular:
a management module 104, designed to manage an application dialog associated with a session between the first entity 10 and a second entity;
a first dispatch/reception module 100, designed to receive from the second entity a proposed list of coding/decoding modules for a session to be established and more generally to dispatch and receive messages relating to the application dialog with the second entity;
a selection module 106, designed to select on the basis of the received list of coding/decoding modules, at least one coding/decoding module to be acquired;
a second dispatch/reception module 102, designed to dispatch a request for a coding/decoding module from a provider entity, and to receive said module in response to said request;
storage means 108, designed to store at least one coding/decoding module;
a processing module 110, designed to prepare the coding/decoding module so as to render it ready for use.

The storage means 108 are for example a memory area, a buffer area (or simply “buffer”) or else an external hard disk.

In another embodiment, the first entity 10 does not comprise any selection module 106. The first entity 10 applies for example a coding/decoding modules acquisition policy consisting in systematically acquiring any module that it is invited to use and which is not at its disposal.

In another embodiment, the first entity 10 does not comprise any processing module 110. This is especially the case when a coding/decoding module acquired by the first entity 10 does not require any processings before being used, or when these processings are carried out by another entity before reception of the module.

FIG. 3 represents a provider entity 20 according to a particular embodiment. It comprises in particular:
storage means 200, designed to store at least one coding/decoding module;
a dispatch/reception module 202, designed to receive a request for acquisition of a coding/decoding module from an entity, and to dispatch said module to it in response to said request;
a processing module 204, designed to render the encoding/decoding module usable by as soon as it is acquired by a requesting entity;
a calculation module 206 designed to calculate a time of making available of the coding/decoding module at the entity.

In another embodiment, the provider entity 20 does not comprise any processing module 204. This is especially the case when a coding/decoding module does not require any processings or when these processings are implemented for example by the entity that requested to acquire the module upon its reception.

In another embodiment, the provider entity 20 does not comprise any calculation module 206.

It should also be noted that in another particular embodiment, when two entities desire to establish a multimedia session but only one of it has the coding/decoding module required for the desired session, the other entity can advantageously play the role of provider entity. A user entity also playing the role of provider entity comprises in particular a selection module, designed to select on the basis of a list of coding/decoding modules that it has at its disposal, at least one coding/decoding module to be provided, and a dispatch/reception module, designed to receive a request for a coding/decoding module, and to dispatch it in response to the request. This embodiment is particularly adapted to two entities operating under one and the same operating system.

The invention is implemented by means of software and/or hardware components. In this regard, the term “module” can correspond in this document either to a software component, or to a hardware component or to a set of hardware components and/or software components, able to implement a function or a set of functions, according to what is described previously for the module concerned.

A software component corresponds to one or more computer programs, one or more subprograms of a program, or more generally to any element of a program or of a piece of software. Such a software component is stored in memory and then loaded and executed by a data processor of a physical entity and is able to access the hardware resources of this physical entity (memories, recording media, communication buses, electronic input/output cards, user interfaces, etc).

In the same manner, a hardware component corresponds to any element of a hardware set. It may or may not be a programmable hardware component, with or without integrated processor for the execution of software. It is for example an integrated circuit, a chip card, an electronic card for the execution of firmware, etc.

In a particular embodiment, the modules 100, 102, 104, 106 and 110 are designed to implement the method of acquisition described above. These are preferably software modules comprising software instructions for executing the steps of the above-described method of acquisition, which are implemented by an entity. The invention therefore also relates to:
a program for an entity, comprising program code instructions intended to control the execution of the steps of the above-described method of acquisition, when said program is executed by said entity;
a recording medium readable by an entity and on which the program for an entity is recorded.

Likewise the modules 202, 204, and 206 are designed to implement the method of acquisition described above. These are preferably software modules comprising software instructions for executing the steps of the above-described method of acquisition, which are implemented by a provider entity. The invention therefore also relates to:
a program for a provider entity, comprising program code instructions intended to control the execution of the steps of the above-described method of acquisition, when said program is executed by said provider entity;
a recording medium readable by a provider entity and on which the program for a provider entity is recorded.

The software modules may be stored in or transmitted by a data medium. The latter may be a hardware storage medium, for example a CD-ROM, a magnetic diskette or a hard disk, or else a transmission medium such as an electrical, optical or radio signal, or a telecommunication network.

1. A method of acquisition in a communication network, of at least one coding/decoding module, so as to encode/decode at least one data stream relating to a session between a first and a second entity, said method being implemented by the first entity and comprising the following steps:
a/reception (E1) of an application message originating from said second entity comprising a list of at least one coding/decoding module proposed for said session, said list comprising at least one item of information relating to at least one provider entity able to provide a coding/decoding module;
b/selection (E3) on the basis of the list received of at least one coding/decoding module to be acquired;
c/acquisition (E10) of said at least one module from a provider entity, an application dialog associated with the session remaining established between the two entities during the acquisition;
d/encoding/decoding (E16) of said at least one data stream relating to said session by means of said at least one module acquired.

2. The method of acquisition as claimed in claim 1, said session currently undergoing establishment and the list not comprising any coding/decoding module common to the two entities, said method furthermore comprising the following steps:
dispatching (E2) of a placement-on-hold message destined for said second entity, making it possible to maintain the application dialog associated with the session;
establishment of the session, once said at least one coding/decoding module is available for use.

3. The method of acquisition as claimed in claim 2, furthermore comprising the emission of a hold message destined for the user of said first entity before establishment of said session, said emission being conditioned by a use of said first entity.

4. The method of acquisition as claimed in claim 1, said application dialog being opened in association with an established session, said first and second entities having negotiated a use of a common coding/decoding module for said encoding/decoding of at least one data stream associated with the session, furthermore comprising a step (F16) of modifying said session so as to encode/decode said at least one data stream by means of the coding/decoding module acquired.

5. The method of acquisition as claimed in claim 1, in which said at least one item of information relating to at least one entity able to provide a coding/decoding module is inserted into said list by an intermediary network entity.

6. The method of acquisition as claimed in claim 1, in which said at least one module to be acquired is selected (E3) as a function of at least one property of the module and of at least one constraint associated with the session.

7. The method of acquisition as claimed in claim 1, furthermore comprising a determination of the provider entity as a function of at least one item of information associated with at least one of said first and second entities.

8. The method of acquisition as claimed in claim 1, in which an item of information relating to said provider entity is obtained by way of a dynamic configuration protocol.

9. An entity (10) designed to acquire in a communication network (1), at least one coding/decoding module, said module being used by the entity to encode/decode at least one data stream relating to a session between the entity (10) and a second entity (40), comprising:
a management module (104), designed to manage an application dialog associated with the session;
a first dispatch/reception module (100), designed to receive from the second entity a proposed list of coding/decoding modules for said session;
a selection module (106), designed to select on the basis of the received list of coding/decoding modules, at least one coding/decoding module to be acquired;
a second dispatch/reception module (102), designed to dispatch a request for a coding/decoding module from a provider entity (20), and to receive said module in response to said request;
storage means (108), designed to store at least one coding/decoding module.

10. A system (30) in a communication network (1), said system (30) comprising:
at least one entity (10) designed to acquire in a communication network (1), at least one coding/decoding module, said module being used by the entity to encode/decode at least one data stream relating to a session between the entity (10) and a second entity (40), comprising;
a management module (104), designed to manage an application dialog associated with the session;
a first dispatch/reception module (100), designed to receive from the second entity a proposed list of coding/decoding modules for said session;
a selection module (106), designed to select on the basis of the received list of coding/decoding modules, at least one coding/decoding module to be acquired;
a second dispatch/reception module (102), designed to dispatch a request for a coding/decoding module from a provider entity (20), and to receive said module in response to said request;
storage means (108), designed to store at least one coding/decoding module;
provider entity (20), in a communication network (1), designed to provide at least one coding/decoding module to said at least one entity so as to encode/decode at least one data stream relating to a session between said first entity and a second entity, comprising:
storage means (200), designed to store at least one coding/decoding module;
a dispatch/reception module (202), designed to receive a request for acquisition of a coding/decoding module from said at least one entity, and to dispatch said module to it in response to said request.

11. The system (30) as claimed in claim 10, in which said provider entity (20) furthermore comprises a processing module (201), designed to render the encoding/decoding module, usable by said at least one entity as soon as it is acquired.

12. The system (30) as claimed in claim 10, in which said provider entity (20) furthermore comprises a calculation module (206), designed to calculate a time of making available of the coding/decoding module at said at least one entity.

13. A program for an entity (10), comprising program code instructions intended to control execution of steps of a method of acquisition in a communication network, of at least one coding/decoding module, so as to encode/decode at least one data stream relating to a session between a first and a second entity, when said program is executed by said entity (10), said method being implemented by the first entity and comprising the following steps:
a/reception (E1) of an application message originating from said second entity comprising a list of at least one coding/decoding module proposed for said session, said list comprising at least one item of information relating to at least one provider entity able to provide a coding/decoding module;
b/selection (E3) on the basis of the list received of at least one coding/decoding module to be acquired;
c/acquisition (E10) of said at least one module from a provider entity, an application dialog associated with the session remaining established between the two entities during the acquisition;
d/encoding/decoding (E16) of said at least one data stream relating to said session by means of said at least one module acquired.

14. A recording medium readable by an entity and on which a program for the entity (10) is recorded, the program comprising program code instructions intended to control execution of steps of a method of acquisition in a communication network, of at least one coding/decoding module, so as to encode/decode at least one data stream relating to a session between a first and a second entity, when said program is executed by said entity (10), said method being implemented by the first entity and comprising the following steps:
a/reception (E1) of an application message originating from said second entity comprising a list of at least one coding/decoding module proposed for said session, said list comprising at least one item of information relating to at least one provider entity able to provide a coding/decoding module;
b/selection (E3) on the basis of the list received of at least one coding/decoding module to be acquired;
c/acquisition (E10) of said at least one module from a provider entity, an application dialog associated with the session remaining established between the two entities during the acquisition;
d/encoding/decoding (E16) of said at least one data stream relating to said session by means of said at least one module acquired.
